(19) United States
(12) Patent Application Publication
(10) Pub. No.: US 2011/0169414 A1
(43) Pub. Date: Jul. 14, 2011

(54) CALIBRATION OF LIGHT ELEMENTS WITHIN A DISPLAY

(75) Inventor: Hans Schmitz, Herkenbosch (NL)

(73) Assignee: NXP B.V., Eindhoven (NL)

(21) Appl. No.: 13/119,320

(22) PCT Filed: Sep. 15, 2009
(86) PCT No.: PCT/IB09/54032

§ 371 Date: Mar. 16, 2011

(30) Foreign Application Priority Data
Sep. 16, 2008 (EP) 08164457.7

(51) Int. Cl. H05B 37/02; G01J 1/00

(52) U.S. Cl. 315/153; 356/213

(57) ABSTRACT

The invention relates to calibrating light emitters (4). In order to avoid blanking of a backlight and also to reduce the number of light sensors (14), it is possible to drive a plurality of light emitters to the pulsed initial driving condition (PWM1-PWM4), shift a start time (T0, T3) of the initial driving condition of a selected one of the light emitters temporally in front of start times (T1, T2) of remaining light emitters, detecting an illumination condition produced by the selected one of the light emitters at the beginning (T3) of a subsequent shifted driving condition of the selected one of the light emitters, determining an adjustment factor for the selected light emitter by comparing a detected illumination condition with a calibration illumination condition, and respectively supplying the selected light emitter with a modified driving condition comprising the initial driving condition modified by the adjustment factor.

### FIELD OF THE INVENTION

The invention relates to the field of display devices. In particular to backlighting modules for displays, in particular flat panel displays. More particularly, the present invention relates to a method and an apparatus for calibrating light elements within the display device.

### BACKGROUND OF THE INVENTION

Flat panel displays, such as liquid crystal displays (LCDs), have gained popularity over the conventional cathode ray tube (CRT) displays in recent years, primarily due to their slimness. However, in contrast to the CRT displays, an LCD requires an additional light source to illuminate the image pixels displayed on the LCD.

Recently, light emitting diodes (LEDs) have been used as a light source for LCD TVs. By using LEDs as a light source, the color saturation of an LCD TV can be improved over current standards. In addition, the advantages of LEDs include a longer life span of more than a hundred thousand hours, and a faster reaction time shorter than a few tens of nano-seconds. Moreover, the European Union has particularly restricted the amount of certain hazardous substances used in electrical and electronic products, e.g. mercury. LEDs, therefore, will gradually replace other lighting sources to serve as the primary light source for LCD TVs.

Because one single LED does not provide enough luminance for the whole backlight, these large screen backlights may include hundreds or even thousands of LED devices. These LEDs may be arranged on the side of a screen (side-lit) or in a matrix behind the screen (direct-lit, backligthing). The technique discussed in here can be used for both implementations, although it is described here for LEDs configured in a matrix behind the screen.

Between individual LEDs there may be a large difference in luminance output at identical current levels, which will have the result, that a backlight consisting of multiple LED devices is not uniformly lit. To make the LED backlight unit providing a uniformly flat lit surface, it is required to calibrate the individual LEDs: the lumen output, e.g the light flux or the radiant flux, of the individual LEDs has to be measured. For this a flux sensor can be used. This is a device that collects photons and turns the energy into a voltage or current that can be used to measure the lumen output of such an LED.

By comparing the light output of the individual LEDs one can change the currents through the individual LEDs or use a PWM (Pulse width modulation) dim factor until all LEDs provide the same output. This will result in a uniformly lit backlight.

FIG. 1 illustrates schematically a circuit for driving a light emitter 2 being comprised of a plurality of light elements 4. The circuit comprises a current source 6 and a switch 8. As can be seen, the switch 8 is driven by a pulsed signal 9. The pulsed signal 9 may be understood as an initial driving condition. As can be seen, a pulsed signal 9 has rising and falling edges. The rising edges may constitute the start times of the driving condition. One cycle of the pulsed signal 10 may be comprised of a high state and a low state. At the end of one cycle, the next cycle starts again with a rising edge of the pulsed signal 10.

It is known from literature that changing the current through a light element 4, e.g. a LED 4, will not only change the luminance output of the LED 4, but will as well change the wavelength of the LED 4. Instead of changing the current through the LED 4, the LED 4 current therefore is kept constant, but this current is switched on and off to control the luminance, e.g. the lumen output of LED 4. This switching is done by switch 8 and pulsed signal 10, where a HIGH state of signal 10 closes switch 8, and a LOW state of signal 10 opens switch 8. Each duty cycle expresses the ratio between having the LED 4 current on or off. If this switching is done at the fast rate, e.g. above 200 Hz, the human eye will interpolate the perceived brightness. The duty cycle allows controlling the lumen output of LED 4.

In order for LEDs 4 to properly provide a white light source of a light emitter 2, e.g. a backlight module, with uniformly distributed spectra, LEDs 4a-4d of different colors, such as red, green, and blue, are used. One problem of using LEDs 4a-4d of different colors to achieve a white light source is the difficulty of maintaining a color balance of the source. This difficulty arises from the fact that the brightness of the LEDs 4 decays as they age. In addition, the decay rates are different for LEDs 4 of different colors. The decay rates also may depend on other factors, such as the temperature of the LEDs 4. Accordingly, the color spectra generated by a multi-color LED 4 light source will shift over the lifetime and the working temperature of the backlight module.

As discussed above, the optical output of light emitters 2 may vary according to several factors. For example, the optical output of LEDs 4 decays during the lifetime of light emitters. The decay rates depend on the particular type of LED 4, as well as the working temperature of LEDs 4. For this reason, the operation illumination condition may shift over time and may no longer constitute the desired operation illumination condition during the lifetime of the light emitters 2. Such a shift is perceivable by human eyes. Therefore, in order for LEDs 4 to maintain the desired operation illumination condition, an initial driving condition must be modified, either manually or periodically, in accordance with decay rates. In addition, in order to precisely control the color balance of LEDs 4 disposed in each local region, LEDs should be adjusted individually.

In order to maintain the color balance, one or more sensors can be disposed in the backlight module. The sensors monitor the change of brightness and the resultant colors of the light emitted from the LEDs 4. The detected brightness and color are then processed and fed back into the driving circuit to properly control the LED 4 light source. The feedback process indeed reduces the overall color shift of the LED 4 light source. However, since optical crosstalk may occur, such a feedback process cannot ensure the color balance and the homogeneity of color spectra of multiple LEDs 4 at certain local regions when all LEDs are lit at the same time.

It is possible to equip every LED 4 with a sensor and thus allow comparing the light levels of all the LEDs 4, but the amount of sensors will make this very expensive. However, it is preferred to use one sensor to measure multiple light elements 4 or light emitters 2.

In order to measure the lumen output coming from one individual LED 4 or one individual light emitter 2, all the other LEDs 4 or all other light emitters 2 in the display of backlight element need to be switched off.

As illustrated in FIG. 2, a backlight 12 can be comprised of a plurality of light elements 4. Two or more light elements 4 can be comprised within one group constituting a light emitter 2. Within backlight 12, there are provided two sensors 14. In order for the sensors 14 to measure the lumen output of a light emitter 2, all other light elements 4 need to be switched off. However, this results in the impossibility of the user to see content on the display, i.e. to watch television.

In order to allow calibration of the initial driving condition providing a constant luminance output of each light emitter, without disturbing or annoying a user with calibration sequences, it is one object of the invention to provide for seamless calibration of light emitters. It is a further object of the invention to provide for sensing lumen output of light emitters without disturbance from spatially neighbouring light emitters. It is a further object to allow for using a reduced number of sensors for measuring a plurality of light emitters within a backlight.

### SUMMARY OF THE INVENTION

These and other objects are solved, according to one aspect, by a calibration method comprising driving a plurality of light emitter with a pulsed initial driving condition, shifting a start time of the initial driving condition of a selected one of the light emitters temporally in front of start times of remaining light emitters, detecting a lamination condition produced by the selected one of the light emitters at the beginning of a subsequent shifted driving condition of the selected one of the light emitters, determining an adjustment factor for the selected light emitter by comparing a detected illumination condition with a calibration illumination condition, and respectively supplying the selected light emitter with a modified driving condition comprising the initial driving condition modified by the adjustment factor.

Driving a plurality of light emitters may comprise driving a plurality of light emitting diodes (LED), organic light emitting diodes (OLED), or any other types of light emitting units. Light emitters may comprise an array or matrix of light elements as well as single light elements. Light emitters may, for example, comprise three or more LEDs having different colour. Light emitters may comprise light elements, which emit substantially white light.

A pulsed initial driving condition may be a signal having high and low states, where high and low states may alternate.

A start time may be a beginning of a rising edge of the initial driving condition. As the initial driving condition may alternate between high and low states, each rising edge of the driving condition, e.g. every time when the driving condition changes into high state, may be considered as start time. Shifting a start time of a selected one of the light emitters temporally in front of start times of remaining light emitters may be understood as shifting the start time of the selected one of the light emitters temporally in relation to the start times of remaining light emitters. Shifting the start time of the selected one of the light emitters temporally in front of start times of remaining light emitters may be accomplished by shifting the start time of the initial driving condition by a certain amount of time backward and remaining the start times of the initial driving condition of the remaining light emitters, or by shifting the start times of the initial driving condition of the remaining light emitters temporally forward and remaining the start time of the initial driving condition of the in selected one of the light emitters. Shifting may be understood as temporally misaligning the start times of the initial drive conditions of the selected one of the light emitters and the remaining light emitters.

An illumination condition may be understood as the light output of the light emitter. For example, the lumen output, the brightness, the luminous flux, the radiant flux, or any other value indicative of an illumination condition may be detected.

As has been mentioned above, the start times of the initial driving conditions of the selected one of the light emitter and the remaining light emitters are misaligned, such that the start time of the initial driving condition of the selected one of the light emitters is temporally in front of the start times of the remaining light emitters. Thus, the rising edge of the start time of the initial driving condition of the selected one of the light emitters is temporally prior to the rising edges of the initial driving conditions of the remaining light emitters. At each end of the initial driving condition, the light emitters usually do not emit light, as the initial driving condition is at the end of a cycle in low state. When having shifted the start time of the initial driving condition of the selected one of the light emitters temporally in front of start times of the initial driving condition of the remaining light emitters, the rising edge of the selected one of the light emitters starts temporally prior to the rising edges of the remaining light emitters. Thus, the subsequent shifted driving condition of the selected one of the light emitters starts prior to the driving conditions of the remaining light emitters. Therefore, when detecting an illumination condition produced by the select one of the light emitters at the beginning of the subsequent shifted driving condition of the selected one of the light emitters, the driving conditions of the remaining light emitters is still in low state and the remaining light emitters do not emit light, whereas the selected one of the light emitters already emits light as the rising edge of the driving condition provides current to the selected one of the light emitters.

As only the selected one of the light emitters emits light at the beginning of a subsequent shifted driving condition, all other remaining light emitters are still driven by an initial driving condition in low state, and the rising edges start later, determining an adjustment factor for the selected light emitter is possible. Only the illumination condition of the selected one of the light emitter is detected. The detected illumination condition is compared with a calibration illumination condition. The calibration illumination condition may be understood as a condition of a brightness, lumen output, radiant flux, luminous flux or any other value indicative of the light output of the light emitter being desired.

When having compared the detected illumination condition with a calibration illumination condition, it is possible to detect deviations between the detected illumination condition and the calibration illumination condition. Such a deviation may be used for supplying the selected light emitter with a modified driving condition. The modified driving condition may account for deviations between the detected illumination condition and a calibration illumination condition. By modifying the driving condition, the lumen output, brightness, luminous flux, radiant flux, or any other value indicative of the light output of the light emitter may be modified. This may be done by modifying the initial driving condition by an adjustment factor. An adjustment factor may, for example, be a factor changing the duty cycle of the initial driving condition. For example, the ratio between the high state and the low state of the signal of the initial driving condition may be changed, thus changing lumen output of the light emitter.

According to embodiments, the steps of shifting, detecting and determining may be repeated sequentially. Thereby, it may be possible to individually select at least parts of the remaining ones of the light emitters. It may be possible, to repeat the above mentioned steps for each light emitter of a backlight, until all light emitters are calibrated and then restart the whole calibration process again.

According to embodiments, detecting an illumination condition may comprise measuring a lumen output of at least one light element within the selected light emitter. For example, it may be possible to measure only one LED within a plurality of LEDs being comprised within a light emitter. For example, it may be possible to switch on one single light element within a selected light emitter and to subsequently switch between single light elements within a light emitter until all light elements within the selected light emitter are calibrated.

A sensor may, according to embodiments, be used for detecting an illumination condition comprising measuring a lumen output. This sensor may, for example, be arranged to measure the light output within a short calibration period. The setting time of the sensor should be less than 1 μs. For example, the sensor may be arranged for measuring the numbers of photons received. In a backlight, the screen diameter may, for example, be larger than 32″ or even larger than 50″. With such diameters, the distance between the sensor and the most remote positioned light emitter may be in the order of 30 to 60 cm. Thus, the sensor might receive very low light levels in the range of 0, 1 to 1 Lux. Thus, the used sensor should measure a light emitted from the selected one of the light emitters during the whole detecting period. The detecting period is defined by the time of misalignment between the start time of the initial driving condition of the selected one of the light emitters, and the start times of the initial driving condition of the remaining light emitters.

In order to allow for measuring the whole period, embodiments provide for driving the sensor with a sample and hold signal. Before starting the light measurement, the sensor content is flushed and thereafter the photons emitted by the selected one of the light emitters are detected until the end of the whole period, which is aligned with the start times of the initial driving conditions of the remaining light emitters.

In order to allow for precise measurement, detecting an illumination condition comprises activating the sensor at the end of each initial driving condition for measuring the lumen output emitted by the selected one of the light emitters. At the end, i.e. some milliseconds or nanoseconds prior to the rising edge of the next cycle of the initial driving condition, the remaining light emitters usually do not emit light. As the start time of the initial driving condition of the selected one of the light emitters is misaligned and thus prior to the start times of the initial driving conditions of the remaining light emitters, at the end of the initial driving conditions of the remaining light emitters, the selected one of the light emitters already emits light. The rising edge of the next cycle of the initial driving condition of the selected light emitter has already started.

In order to provide for exact measurement, the sensor is activated at a time instance shifted temporally in front of the end of the initial driving condition by the same value as the selected one of the light emitters is shifted temporally in front of start times of remaining light emitters. For example, the start time T0 of the selected one of the light emitters is 5 μs prior to the start times of the initial driving condition of the remaining one of the light emitters. In this case the sensor is activated 5 μs prior to the start times of a subsequent cycle of driving conditions of the remaining light emitters. This is at the end of the initial driving conditions of the remaining light emitters.

A sensor that is installed in modern display devices, such as television devices, will receive light from the backside, but additionally will also pick up light from the surrounding neighborhood, like sunlight or light from a lamp that shines the screen of the television into the sensor. This ambient light acts as a disturbance for the control loop, since the light is added to the light received from the backlight LEDs. Mathematically, the ambient light can be seen as an offset to the light values that are obtained when reading the backlight luminance value. In order to calibrate this offset out of the control loop, the ambient light level should be measured. For these reasons, embodiments provide for detecting a second illumination condition of an ambient lighting element.

According to embodiments, the second illumination condition of the ambient lighting element may comprise activating the sensor at the end of initial driving condition. As has been discussed above, at the end of the initial driving condition, the state of the driving signal is low, thus the light emitters do not emit light.

For example, embodiments provide detecting the second illumination condition of the ambient lighting element by activating the sensor at a time instance shifted temporally in front of the end of each initial driving condition by the same value as the selected one of the light emitters is shifted temporally in front of start times of remaining light emitters plus at least one clock cycle. Thus, the ambient lighting offset is calibrated shortly before the selected one of the light emitters is calibrated. For example, two clock periods at the end of the initial driving condition may be used for calibrating first the ambient lighting element and then the selected one of the light emitters.

In order to allow for using one sensor for measuring different light emitters, embodiments provide for outputting the measured lumen output and resetting the sensor.

In order to allow for adjusting the modified driving condition, the measured result needs to be known. Therefore, embodiments provide for storing the measured lumen output in one or more registers.

According to embodiments, the initial driving condition may have a duration of more than one clock periods, wherein the driving condition comprises driving the light emitter with a current at a first set of clock periods within the duration of the initial driving condition and driving the light emitter essentially without a current at a second set of clock periods within the duration of the initial drive condition. For example, at 12 bit word may be used to define the clock periods, within which the driving condition is at high state or at low state. With 12 bits, 4.096 clock periods may be addressed. For example, it may be possible to define, that the initial driving condition as well as the modified driving condition may have the high state only within the first 4.094 clock cycles. Clock cycles 4.094 and 4.095 may be reserved and not used for high state in the initial driving condition and the modified driving condition. Thus clock periods 4.094 and 4.095 may be used for a) measuring the ambient lighting offset, and b) measuring the selected one of the light emitters. For example, the start time of the initial driving condition of the selected one of the light emitters may be shifted by one clock period. In this case, the start time of the initial driving condition of the selected light emitter is already at position 4.095 of the initial driving condition of the remaining light emitters. The ambient lighting element may be activated at position 4.094. Thus, the last two clock cycles may be reserved. One duty cycle of a driving condition may last 2 h clock cycles, where n is the number of bits reserved for addressing the duty cycle.

As has been mentioned above, the sensor needs to have a short setting time. According to embodiments, the setting time of the sensor may be less than one clock cycle, such as less than one 1 μs, preferably less than 500 ns.

The repetition sequence may be performed regularly in determined intervals, in particular in time intervals of 1 minute, 5 minutes, or 10 minutes. Thus, every 1 minute, 5 minutes or 10 minutes, all light emitters within a display panel may be calibrated.

According to embodiments, the start times of the initial driving condition of the remaining light emitters may be shifted temporally by delaying or advancing the respective start times. It has been found that the rising edges of the light emitters need not necessarily coincide at the same moment. When the start times of the initial driving conditions vary, the more even lighting impression is created, as not all light emitters are activated at the same moment in time. However, it should be noted the start time of the initial driving condition of the selected one of the light emitters is the first start time.

According to embodiments, the initial driving condition may comprise pulse width modulated duty cycles with switching the light elements on and off. A duty cycle of an initial driving condition may comprise 2″ clock cycles, when n bits are used, i.e. 4.096 with 12 bits. Other numbers of bits and numbers of clock cycles may also be used. Within each duty cycle, the initial driving condition and the modified driving condition has a high state and a low state. The ratio between the high state and the low state within the initial driving condition and the modified driving condition defines the lumen output of the lighting element. The longer the high condition, the higher the lumen output.

According to embodiments, the initial driving condition may comprise a pulse width modulated current having an initial pulse width. This initial pulse width may have a certain number of clock cycles. The initial pulse width may define the initial length of the high state and thus the initial lumen output. Due to temperature drift and decay, the lumen output may vary even when remaining initial pulse width. Thus, the modified driving condition may have a different pulse width in order to account for a change in lumen output. This difference in pulse width may be defined in the adjustment factor.

According to embodiments, the adjustment factor may be the ratio of the detected illumination condition to the calibration illumination condition. By that, the adjustment factor may inform about the difference between the desired lumen output and the detected lumen output. The adjustment factor may thus adjust the modified driving condition, e.g. the pulse width of the current in high state of the modified driving condition.

According to a further aspect, there is provided an apparatus comprising a driver arrange a for driving a plurality of light emitters with a pulsed initial driving condition, a control circuit arranged for shifting a start time of the initial driving condition of a selected one of the emitters temporally in front of start times of remaining light emitters, a sensor arranged for detecting an illumination condition produced by the selected one of the light emitters at the beginning of a subsequent shifted driving condition of the selected one of the light emitters, a comparator arranged for determining an adjustment factor for the selected light emitter by comparing a detected illumination condition with a calibration illumination condition, wherein the driver is arranged for respectively supplying the selected light emitter with a modified driving condition comprising the initial driving condition modified by the adjustment factor.

A further aspect is a display comprising such an apparatus.

A further aspect is a computer program comprising instructions operating a processor for driving a plurality of light emitters with a pulsed initial driving condition, shifting a start time of the initial driving condition of a selected one of the light emitters temporally in front of start times of remaining light emitters, detecting an illumination condition produced by the selected one of the light emitters at the beginning of the subsequent shifted driving condition of the selected one of the light emitters, determining an adjustment factor for the selected light emitter by comparing a detected illumination condition with a calibration illumination condition, and respectively supplying the selected light emitter with the modified driving condition comprising the initial driving condition modified by the adjustment factor.

The computer program includes also a micro-computer program and the processor includes also a state machine.

A further aspect is a sensor architecture for calibrating light emitters comprising an input arranged for receiving a sample and hold signal, an activator arranged for activating the sensor at the end of each initial driving condition for measuring a lumen output emitted by a selected one of the light emitters, and one or more registers arranged for storing the measured lumen output and ambient lighting offset.

These and other aspects will be apparent from and elucidated with reference to the following Figures. In the Figures show:

### BRIEF DESCRIPTION OF THE DRAWINGS

FIG. 1 a circuit according to prior art;

FIG. 2 a backlight panel;

FIG. 3 schematically an array of light emitters and a sensor together with respective initial driving conditions;

FIG. 4 a pulse width modulated initial driving condition;

FIG. 5 a shifted initial driving condition for selected one of light emitters and the initial driving conditions of a remaining light emitters;

FIG. 6 an initial driving condition with ambient lighting element measurement;

FIG. 7 a detail of an overall sensor measurement;

FIG. 8 schematically a sensor according to embodiments together with the drive signals.

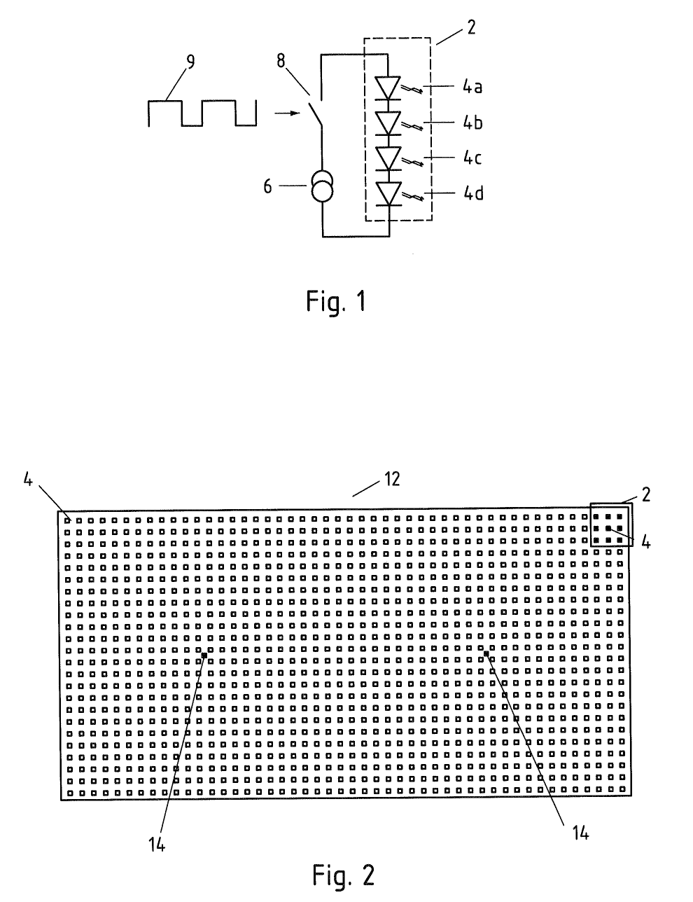

### DETAILED DESCRIPTION OF THE DRAWINGS

The present invention is further elucidated by the following figures and examples, which are not intended to limit the scope of the invention. The person skilled in the art will understand that various embodiments may be combined.

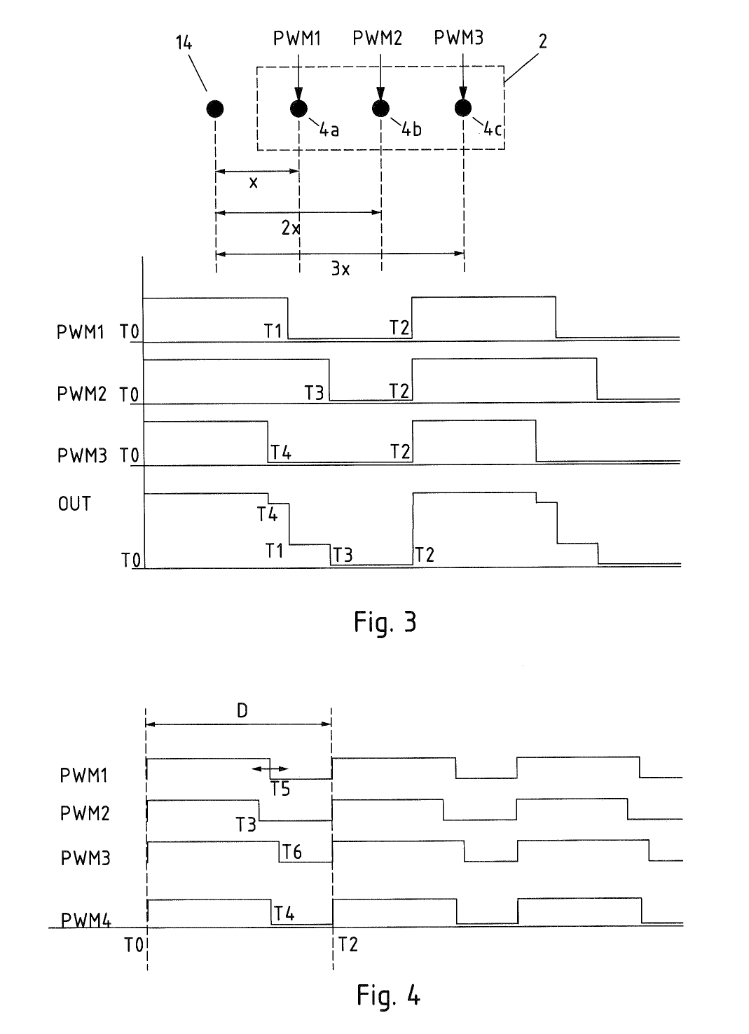

FIG. 3 illustrates a light emitter 2 having 3 light elements 4, in particular LEDs. The following description refers to providing each LED with an initial driving condition. It is however to be understood, that each LED 4 as described above, can also be one single light emitter 2 and the method applied may be also applied to a light emitter rather than single LEDs 4. Further illustrated is a sensor 14. The sensor 14 is located at distances x, 2x, 3x from the LEDs 4. Each LED 4 is applied with an input current. The input current can be a pulsed signal, for example a pulse width modulated signal. The pulse width modulated signal applied to the respective LEDs 4 is illustrated below in FIG. 3. A signal PWM1 is applied onto a LED 4a, a signal PWM2 is applied to LED 4b and a signal PWM3 is applied to LED 4c. Signal PWM1 is in high state from T0 to T1. From T1 to T2, signal PWM1 is in low state. The duration between T0 and T2 is one duty cycle. The ratio between the time T1-T0 and T2-T1 constitutes the duty cycle. The longer T0 to T1, the brighter LED 4.

Signal PWM2 is applied to LED 4b. As can be seen, signal PWM2 is in high state from T0 to T3 and in low state from T3 to T2. As the time between T0 and T3 is longer than the time between T0 and T1, LED 4b outputs more light, e.g. is brighter.

Further, signal PWM3 is in high state from T0 to T4 and in low state from T4 to T2. This signal PWM3 is applied into LED 4c. As can be seen, each duty cycle of the signals PWM1, PWM2, PWM3 starts from T0 to T2 and starts again at T2. One duty cycle may be one driving condition. The rising edge of the duty cycle of each of the signals PWM1-3 is at T0 and the falling edges are at T1, T3, T4. The resulting light output, measured at sensor 14, is also illustrated as signal OUT. As can be seen, between T0 and T4, the light signals of LEDs 4a, 4b, 4c are summed up. Between T4 and T1, only the LEDs 4a, 4b are still operative, thus the overall output is lower. Between T1 and T3, only LED 4b is operative and the overall output is lowest. Between T3 and T2, all LEDs 4 are inoperative. As can be seen, at the end of the driving condition, which is between T0 and T2 for all LEDs, the signals are in low state.

Such a situation is further illustrated in FIG. 4, where four signals PWM1-4 are shown. Each signal PWM1-4 constitutes repeating driving conditions for a respective light emitter 2 or light element 4. All signals have a rising edge at T0. All signals have a duty cycle between T0 and T2. At T2, the same duty cycle again is applied. The signals are thus repetitive. The ratio between high states and low states of each of the signals can be changed within each duty cycle. Thus, the initial driving condition can be changed into the modified driving condition. A duration D between T0 and T2 can be plurality of clock cycles, where the number of clock cycles may be 4.096, and may be expressed by 12 bit resolution. The duration T0-T5 may be coded as 100000000000, the duration T0-T4 may be coded as 011111100000, the duration T0-T3 may be coded as 100010000000 and the duration T0-T4 may be coded as 011111101000. Different resolutions may also be possible. The time T0-T2 can be divided into 4.096 cycles starting from 0 and ending at 4.095. It may be possible, that the last two clock cycles 4.094, and 4.095 may intentionally be reserved, such that no signal PWM1-4 can be in high state at these two last clock cycles.

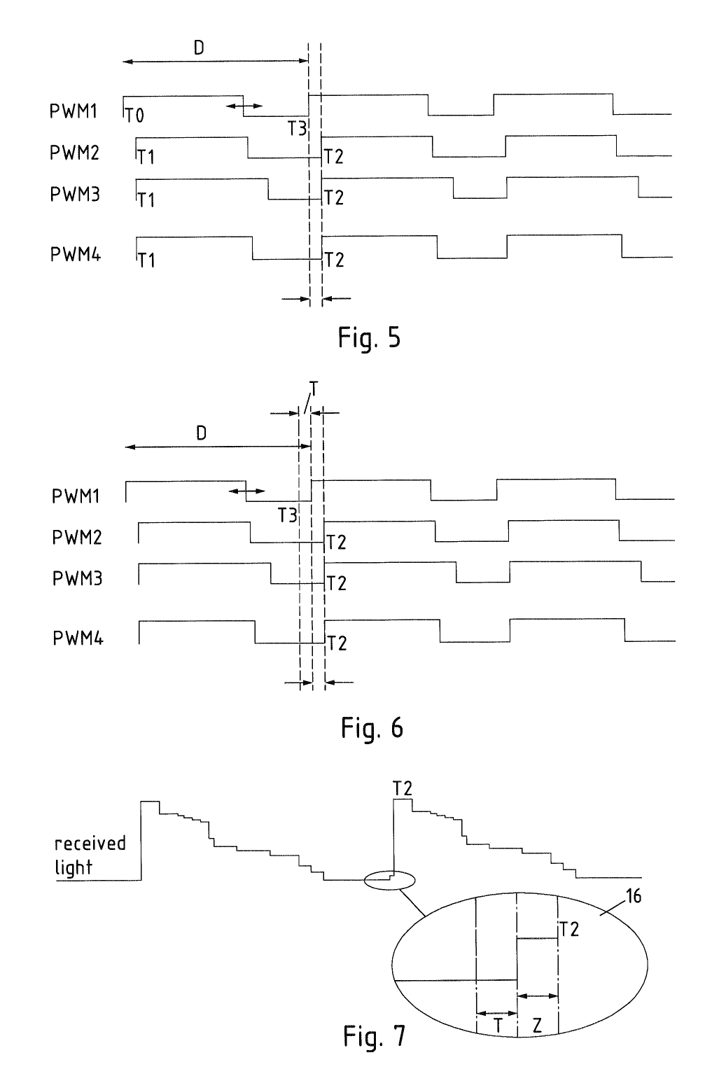

Illustrated in FIG. 5 is a signal PWM1 as an initial drive condition of a selected one of a plurality of light emitters, which start time T0 is prior to the start times T1 of all other initial drive conditions of the signals PWM2-4. With such a shift, which may be one clock cycle, at the end of the duty cycle of the signals PWM2-4, the signal PWM1 already has a rising edge at T3. Between T3 and T2 only a selected one of the light emitters, which is fed by signal PWM1, is lit. During this time, it is possible to measure, using the sensor 14, the light emitted by the selected one of the light emitters.

In FIG. 6 there is further illustrated a shift of the initial driving condition of signal PWM1 by one clock cycle with respect to the remaining signal PWM2-4, feeding the remaining light emitters. As can be seen, between T3 and T2, only the signal PWM1 is in high state. If the clock cycle 4.094 is also reserved, no initial drive condition is in high state and thus no light emitter is lit. At this time T, it is possible to calibrate ambient light offset using the sensor. Thus, the sensor may first in the time instance T calibrate the ambient light offset and in the time between T3 and T2 calibrate the selected one of the light emitters. The shift illustrated for signal PWM1 may sequentially be applied onto each signal PWM2-4, thus allowing calibrating the respective selected light emitters, which correspond to the respective signals.

FIG. 7 illustrates the received light at a sensor 14. As can be seen, the received light may be a summation of the light outputs of each of the light emitters 2. At the end of the duty cycle, which is temporally before T2, there are two clock cycles illustrated in detail 16. At time T it is possible to measure and calibrate the ambient light emitter and at time Z, which corresponds to the number of clock cycles by which the initial drive condition is shifted, the respective light emitter may be calibrated. The amount of light received from a distant LED may be lower in amplitude than the amount of light received from a LED at close range.

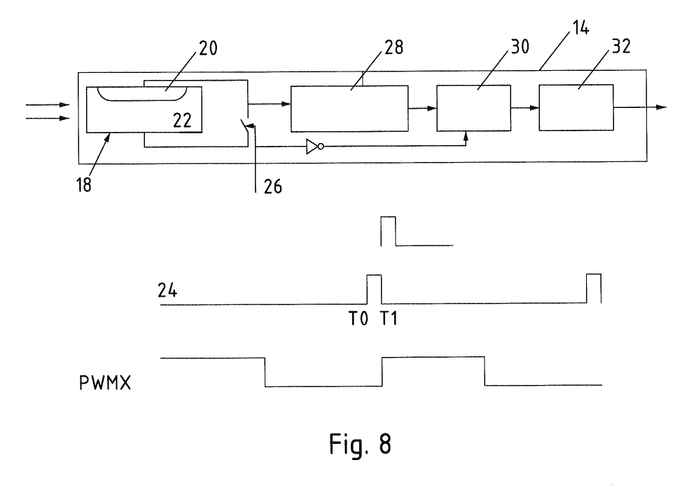

FIG. 8 illustrates a sensor 14. A sensor 14 may comprise a photo-diode 18, which is light sensitive. Diode 18 is comprised of an N-doted well 20 and a P-doted substrate 22. The photo-diode 18 is driven by switch 26, which is applied with a drive signal 24. When drive signal 24 is high, switch 26 is closed, and when drive signal 24 is low, switch 26 is open. When the switch 26 is closed, photo-diode 18 is a short cut. When the switch 26 is open, the output voltage of diode 18 is indicative of the number of photons hitting photo-diodes 18. A converter 28 converts the output voltage into an analogue signal. The analogue signal is converted in analogue to digital converter 30 into a digital word, which is stored in register 32. An initial drive condition for a selected one of the light emitters is further illustrated as PWMX. As can be seen, shortly before PWMX has a rising edge, the switch 26 is closed. At the time T1, the switch is opened again. The sensor 18 activated for the same number of clock cycles, as the initial drive condition is shifted. During this time instance, the only photons arriving at photo-diode 18 are the photons from the selected one of the light emitters. Thus, the output of photo-diode 18 is indicative of the lumen output of the selected light emitter. This lumen output is stored in register 32.

It is possible, to compare the detected lumen output as an illumination condition and calibration illumination condition. The ratio between the detected illumination condition and the calibration illumination condition may be used for calculating an adjustment factor. The adjustment factor may be used for changing the initial drive condition for each LED into the modified drive condition, such that the number of clock cycles, within which the respective drive signal PWM is in high state is increased or reduced, depending on the ratio of the detected illumination condition and the calibration illumination condition. Thus, by using the sensor, which senses only light emitted from one light emitter at a certain time instance, where all other light emitters are blanked, it is possible, to calibrate the respective light emitter.

1. Calibration method comprising:
driving a plurality of light emitters with a pulsed initial driving condition,
shifting a start time of the initial driving condition of a selected one of the light emitters temporally in front of start times of remaining light emitters,
detecting an illumination condition produced by the selected one of the light emitters at the beginning of a subsequent shifted driving condition of the selected one of the light emitters,
determining an adjustment factor for the selected light emitter by comparing a detected illumination condition with a calibration illumination condition,
respectively supplying the selected light emitter with a modified driving condition comprising the initial driving condition modified by the adjustment factor.

2. The method of claim 1, wherein detecting an illumination condition comprises measuring lumen output of at least one lighting element within the selected light emitter.

3. The method of claim 2, wherein detecting an illumination condition comprises driving the sensor with a sample and hold signal.

4. The method of claim 3, wherein detecting an illumination condition of a selected light element comprises activating the sensor at a time instance shifted temporally in front of the end of each initial driving condition by the same value as the selected one of the light emitters is shifted temporally in front of start times of remaining light emitters.

5. The method of claim 3, further comprising detecting a second illumination condition of an ambient lighting element.

6. The method of claim 5, wherein detecting the second illumination condition of the ambient lighting element comprises activating the sensor at the end of each initial driving condition.

7. The method of claim 6, wherein detecting the second illumination condition of the ambient lighting element comprises activating the sensor at a time instance shifted temporally in front of the end of each initial driving condition by the same value as the selected one of the light emitters is shifted temporally in front of start times of remaining light emitters plus at least one clock cycle.

8. The method of claim 1, wherein the initial driving condition has a duration of more than one clock periods, wherein the driving condition comprises driving the light emitter with a current at a first set of c lock periods within the duration of the initial drive condition and driving the light emitter essentially without a current at a second set of clock periods within the duration of the initial drive condition.

9. The method of claim 1, wherein shifting a start time of the initial driving condition of a selected one of the light emitters in front of start times of remaining light emitters comprises temporally shifting of the start time by at least one clock period.

10. The method of claim 1, wherein the initial driving condition comprises pulse width modulated duty cycles with switching the light element on and off.

11. The method of claim 1, wherein the light emitters comprise light emitting diodes of a plurality of colors.

12. Calibration apparatus comprising:
a driver arranged for driving a plurality of light emitters with a pulsed initial driving condition,
a control circuit arranged for shifting a start time of the initial driving condition of a selected one of the light emitters temporally in front of start times of remaining light emitters,
a sensor arranged for detecting an illumination condition produced by the selected one of the light emitters at the beginning of a subsequent shifted driving condition of the selected one of the light emitters,
comparator arranged for determining an adjustment factor for the selected light emitter by comparing a detected illumination condition with a calibration illumination condition,
wherein the driver is arranged for respectively supplying the selected light emitter with a modified driving condition comprising the initial driving condition modified by the adjustment factor.

13. A backlighting module of a display comprising an apparatus of claim 12.

14. Computer program comprising instructions operating a processor for:
driving a plurality of light emitters with a pulsed initial driving condition,
shifting a start time of the initial driving condition of a selected one of the light emitters temporally in front of start times of remaining light emitters,
detecting an illumination condition produced by the selected one of the light emitters at the beginning of a subsequent shifted driving condition of the selected one of the light emitters,
determining an adjustment factor for the selected light emitter by comparing a detected illumination condition with a calibration illumination condition,
respectively supplying the selected light emitter with a modified driving condition comprising the initial driving condition modified by the adjustment factor.

15. A sensor architecture for calibrating light emitters, comprising:
an input arranged for receiving a sample and hold signal,
an activator arranged for activating the sensor at the end of each initial
driving condition for measuring a lumen output emitted by a selected one of the light emitters, and
one or more registers arranged for storing the measured lumen output and ambient lighting offset.
